(19) United States
(12) Patent Application Publication
(10) Pub. No.: US 2021/0331799 A1
(43) Pub. Date: Oct. 28, 2021

(54) METHOD, DEVICE AND SYSTEM FOR PROVIDING FLIGHT PATH OF UNMANNED AERIAL VEHICLE

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 17/278,287

(22) PCT Filed: Sep. 27, 2018
(86) PCT No.: PCT/CN2018/107985

§ 371 Date: Mar. 19, 2021

(51) Int. Cl. B64C 39/02; H04W 68/00; H04B 7/185; H04W 76/10; G05D 1/10; G05D 1/00; G08G 5/00

(52) U.S. Cl. CPC B64C 39/024; H04W 68/005; H04B 7/18506; B64C 2201/146; G05D 1/101; G05D 1/0022; G08G 5/0069; H04W 76/10

(57) ABSTRACT

A method for providing a flight path of an unmanned aerial vehicle (UAV) includes: obtaining information of an UAV in an idle state obtained by a first access network device from a management system of the UAV, the information of the UAV including an identification of the UAV and flight path information of the UAV; determining, according to the identification of the UAV, a target tracking area in which the UAV is located; sending a paging signaling to access network devices within the target tracking area, the paging signaling being configured to instruct paging the UAV; and sending the flight path information of the UAV to a second access network device after a connection between the second access network device in the target tracking area and the UAV is established successfully.

### TECHNICAL FIELD

The present disclosure relates to the field of communication technology, and more particularly, to a method, device and system for providing flight path of unmanned aerial vehicle.

### BACKGROUND

An aircraft that does not require human to drive is simply referred to as Unmanned Aerial Vehicle (UAV). Currently, UAV has been used in various industries, such as vegetation protection, film shooting, surveying and mapping, scientific investigation, power inspection, and the like.

The flight of UAV includes two modes. One is a fixed mode, i.e., the UAV flies along a planned flight path. The other is a dynamic mode, i.e. the UAV flies according to real-time control of the controller.

For the fixed mode, how does the UAV obtain the flight path from the management system of the UAV is an urgent problem to be solved.

### SUMMARY

Embodiments of the present disclosure provide a method, device and system for providing flight path of Unmanned Aerial Vehicle (UAV), which may solve the problem of obtaining a flight path from a management system of an UAV by a UAV. The technical solution includes the following operations.

According to a first aspect of embodiments of the present disclosure, a method for providing flight path of UAV is provided. The method includes the following operations.

A first core network device obtains information of an UAV in an idle state obtained by a first access network device from a management system of the UAV. The information of the UAV includes an identification of the UAV and flight path information of the UAV.

The first core network device determines a target tracking area in which the UAV is located according to the identification of the drone.

The first core network device sends a paging signaling to access network devices within the target tracking area. The paging signaling is used to instruct paging the UAV.

The first core network device sends the flight path information of the UAV to a second access network device after a connection between the second access network device in the target tracking area and the UAV is established successfully.

Optionally, the operation that the first core network device obtains the information of the UAC in the idle state obtained by the first access network device from the management system of the UAV includes the following operation.

The first core network device receives the information of the UAV from the first access network device.

Optionally, the operation that the first core network device obtains the information of the UAC in the idle state obtained by the first access network device from the management system of the UAV includes the following operation.

The first core network device receives the information of the UAV from a second core network device. The information of the UAV is received by the second core network device from the first access network device or other core network device.

Optionally, the method further includes the following operations.

The first core network device detects, according to the identification of the UAV, whether the UAV is within a service range of the first core network device.

In response to the UAV being within the service range of the first core network device, the first core network device performs, according to the identification of the UAV, the step of determining the target tracking area in which the UAV is located.

Optionally, the method further includes the following operation.

In response to the UAV being not within the service range of the first core network device, the first core network device sends the information of the UAV to other core network devices.

Optionally, the method further includes the following operations.

The first core network device receives a connection establishment complete message sent by the second access network device, wherein the connection establishment complete message is used to indicate that the connection between the second access network device and the UAV is established successfully.

The first core network device performs the step of sending the flight path information of the UAC to the second access network device after the connection establishment complete message is received.

According to a second aspect of embodiments of the present disclosure, a method for providing a flight path of an Unmanned Aerial Vehicle (UAV) is provided. The method includes the following operations.

A second access network device receives paging signaling sent by a first core network device. The paging signaling is used to instruct paging an UAV in an idle state, and the second access network device is located within a target tracking area in which the UAV is located.

In response to a connection between the second access network device and the UAV being established successfully, the second access network device obtains flight path information of the UAV from the first core network device.

The second access network device sends the flight path information to the UAV.

Optionally, the operation that the second access network device obtains flight path information of the UAV from the first core network device includes the following operations.

The second access network device sends a connection establishment complete message to the first core network device, wherein the connection establishment complete message is used to indicate that the the connection between the second access network device and the UAV is established successfully.

The second access network device receives the flight path information of the UAV sent by the first core network device.

Optionally, the method further includes the following operations.

The second access network device sends, according to the paging signaling, a paging message for paging the UAV.

The second access network device receives a connection establishment request, which is sent by the UAV after receiving the paging message.

The second access network device establishes the connection with the UAV according to the connection establishment request.

According to a third aspect of embodiments of the present disclosure, an apparatus for providing a flight path of an Unmanned Aerial Vehicle (UAV), applicable to a first core network device, is provided. The apparatus includes an obtaining module, a determination module, and a sending module.

The obtaining module is configured to obtain information of an UAV in an idle state obtained by a first access network device from a management system of the UAV, wherein the information of the UAV includes an identification of the UAV and flight path information of the UAV.

The determination module is configured to determine, according to the identification of the UAV, a target tracking area in which the drone is located.

The sending module is configured to send a paging signaling to access network devices within the target tracking area, wherein the paging signaling is used to instruct paging the UAV.

The sending module is further configured to send the flight path information of the UAV to a second access network device after a connection between the second access network device in the target tracking area and the UAV is established successfully.

Optionally, the obtaining module is configured to receive the information of the UAV from the first access network device.

Optionally, the obtaining module is configured to receive the information of the UAV from a second core network device, wherein the information of the UAV is received by the second core network device from the first access network device or other core network device.

Optionally, the apparatus further includes a detection module.

The detection module is configured to detect, according to the identification of the UAV, whether the UAV is within a service range of the first core network device.

The determination module is further configured to: in response to the UAV being within the service range of the first core network device, determine, according to the identification of the UAV, the target tracking area in which the UAV is located.

Optionally, the sending module is further configured to: in response to the UAV being not within the service range of the first core network device, send the information of the UAV to other core network devices.

Optionally, the apparatus further includes a receiving module.

The receiving module is configured to receive a connection establishment complete message sent by the second access network device, wherein the connection establishment complete message is used to indicate that the connection between the second access network device and the UAV is established successfully.

The sending module is further configured to send the flight path information of the UAV to the second access network device after the connection establishment complete message is received.

According to a fourth aspect of embodiments of the present disclosure, an apparatus for providing a flight path of an Unmanned Aerial Vehicle (UAV), applicable to a second access network device, is provided. The apparatus includes a receiving module, an obtaining module and a sending module.

The receiving module is configured to receive paging signaling sent by a first core network device. The paging signaling is used to instruct paging an UAV in an idle state, and the second access network device is located within a target tracking area in which the drone is located.

The obtaining module is configured to: in response to the connection with the UAV being established successfully, obtain flight path information of the UAV from the first core network device.

The sending module is configured to send the flight path information to the UAV.

Optionally, the obtaining module is configured to: send a connection establishment complete message to the first core network device, and receive the flight path information of the UAV sent by the first core network device. The connection establishment complete message is used to indicate that the connection between the second access network device and the UAV is established successfully.

Optionally, the apparatus further includes a connection establishment module.

The sending module is further configured to send, according to the paging signaling, a paging message for paging the UAV.

The receiving module is further configured to receive a connection establishment request, which is sent by the UAV after receiving the paging message.

The connection establishment module is further configured to establish the connection with the UAV according to the connection establishment request.

According to a fifth aspect of embodiments of the present disclosure, a device for providing a flight path of an Unmanned Aerial Vehicle (UAV), applicable to a first core network device, is provided. The device includes a processor and memory for storing instructions executable for the processor.

The processor is configured to obtain information of an UAV in an idle state obtained by a first access network device from a management system of the UAV, where the information of the UAV includes an identification of the UAV and flight path information of the UAV; determine, according to the identification of the UAV, a target tracking area in which the UAV is located; send a paging signaling to access network devices within the target tracking area, wherein the paging signaling is used to instruct paging the UAV; and send the flight path information of the UAV to a second access network device after a connection between the second access network device in the target tracking area and the UAV is established successfully.

According to a sixth aspect of embodiments of the present disclosure, a device for providing a flight path of an Unmanned Aerial Vehicle (UAV), applicable to a second access network device, is provided. The device includes a processor and memory for storing instructions executable for the processor.

The processor is configured to receive paging signaling sent by a first core network device, where the paging signaling is used to instruct paging an UAV in an idle state, and the second access network device is located within a target tracking area in which the UAV is located; in response to a connection with the UAV being successfully established, obtain flight path information of the UAV from the first core network device; and send the flight path information to the UAV.

According to a seventh aspect of embodiments of the present disclosure, a system for providing a flight path of an Unmanned Aerial Vehicle (UAV) is provided. The system includes a first core network device and a second access network device.

The first core network device includes the apparatus as mentioned in the third aspect, and the second access network device includes the apparatus as mentioned in the fourth aspect; or the first core network device includes the device as mentioned in the fifth aspect, and the second access network device includes the device as mentioned in the sixth aspect.

According to an eighth aspect of embodiments of the present disclosure, a non-transitory computer-readable storage medium, in which computer programs are stored, is provided. When the computer programs are executed by a processor, the steps of the method described in the first aspect, or the steps of the method described in the second aspect are implemented.

The technical solution provided in the embodiments of the present disclosure may include the following beneficial effects.

For the UAV in an idle state, after the flight path information of the UAV is obtained from the access network devices by the core network devices, the target tracking area in which the UAV is located is searched, then the access network devices in the target tracking area is instructed to page the UAV. After any one of access network devices finds the UAV and successfully establishes a connection with the UAV, the core network device sends the flight path information to the UAV through the access network device. Therefore, the transmission of the flight path information of UAV is implemented, thereby enabling the UAV to obtain the flight path information.

It should be understood that the above general descriptions and the detailed descriptions below are only exemplary and explanatory, and are not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the disclosure.

FIG. 1 is a schematic diagram showing a network architecture according to an exemplary embodiment.

FIG. 2 is a flowchart showing a method for providing a flight path of an Unmanned Aerial Vehicle (UAV) according to an exemplary embodiment.

FIG. 3 is a flowchart showing a method for providing a flight path of an Unmanned Aerial Vehicle (UAV) according to another exemplary embodiment.

FIG. 4 is a flowchart showing a method for providing a flight path of an Unmanned Aerial Vehicle (UAV) according to another exemplary embodiment.

FIG. 5 is a block diagram showing an apparatus for providing a flight path of an Unmanned Aerial Vehicle (UAV) according to an exemplary embodiment.

FIG. 6 is a block diagram showing an apparatus for providing a flight path of an Unmanned Aerial Vehicle (UAV) according to another exemplary embodiment.

FIG. 7 is a schematic structural diagram showing a core network device according to an exemplary embodiment.

FIG. 8 is a schematic structural diagram showing an access network device according to an exemplary embodiment.

### DETAILED DESCRIPTION

Exemplary embodiments will be described in detail herein, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The network architecture and service scenario described in the embodiments of the present disclosure are intended to illustrate the technical solution of the embodiments of the present disclosure more clearly, and do not constitute a limitation to the technical solution provided by the embodiments of the present disclosure. Those of ordinary skill in the art will know that with the evolution of network architecture and the emergence of new business scenarios, the technical solutions provided by the embodiments of the present disclosure are also applicable to similar technical problems.

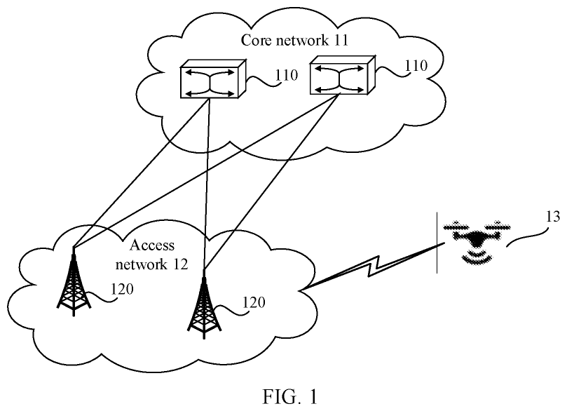

FIG. 1 is a schematic diagram showing a network architecture according to an exemplary embodiment. The network architecture may include a core network 11, an access network 12, and an Unmanned Aerial Vehicle (UAV) 13.

Several core network devices 110 are included in the core network 11. The functions of the core network devices 110 are mainly providing user connection, managing users, performing bearers for services, and providing an interface to an external network as a bearer network. For example, Mobility Management Entity (MME), Serving Gateway (S-GW), and PDN Gateway (P-GW) may be included in a core network of a Long Term Evolution (LTE) system. Access and Mobility Management Function (AMF) entity, User Plane Function (UPF) entity, and Session Management Function (SMF) entity may be included in a core network of the 5G NR (New Radio) system.

Several access network devices 120 are included in the access network 12. The access network devices 120 communicate with the core network devices 110 via a certain air interface technology, such as the S1 interface in the LTE system and the NG interface in the 5G NR system. The access network devices 120 may be Base Stations (BSs), which are apparatuses deployed in the access network for providing a wireless communication function for terminals. The base stations may include various forms of acer stations, micro base stations, relay stations, access points, and the like. In systems employing different radio access technologies, the names of devices having a base station function may be different. For example, in LTE systems, they are referred to as eNodeB or eNB, and in the 5G NR system, they are referred to as gNodeB or gNB. With the evolution of communication technologies, the name “base station” may be changed. For ease of description, the above apparatus for providing a wireless communication function for terminals in the present disclosure are collectively referred to as access network device.

The access network devices 120 are used to provide services for the UAV 13. A wireless connection between the UAV 13 and the access network devices 120 may be established. For example, UAV 13 communicates with access network devices 120 via a certain air interface technology, such as via cellular technology. The access network devices 120 may control the UAV 13 through the above radio connection, and the UAV 13 may work under the control of the access network devices 120.

Alternatively, the access network devices 120 are used to provide services for the UAV 13 and the terminals. The terminals may include various handheld devices with a wireless communication function, in-vehicle devices, wearable devices, computing devices, or other processing devices connected to a wireless modem, as well as various forms of User Equipment (UE), Mobile Stations (MSs), terminal devices, and the like. For ease of description, the above devices are collectively referred to as terminals.

UAV 13 is an abbreviation for Unmanned Aerial Vehicle and is an unmanned aircraft operated by use of a radio remote control device and a self-contained program control device. The UAV is actually a general term for unmanned aircrafts and may include unmanned fixed-wing aircraft, unmanned vertical cranes, unmanned airships, unmanned helicopters, unmanned multi-rotor aircraft, unmanned parachute aircraft, and the like.

The UAV 13 is widely used in the fields of aerial photography, agriculture, plant protection, miniature self-photography, express transportation, disaster relief, observation of wildlife, monitoring of contagion disease, mapping, news reporting, power patrol, disaster relief, film shooting, making romance, and the like. To further expand the scope of application of UAV 13, international standards organizations have also initiated projects aimed at studying and standardizing how to enable cellular networks to provide services meeting requirements for UAV 13.

The technical solution described in the embodiments of the present disclosure may be applicable to an LTE system, or may be applicable to a subsequent evolution system of the LTE system, such as an LTE-Advanced (LTE-A) system or a 5G NR system.

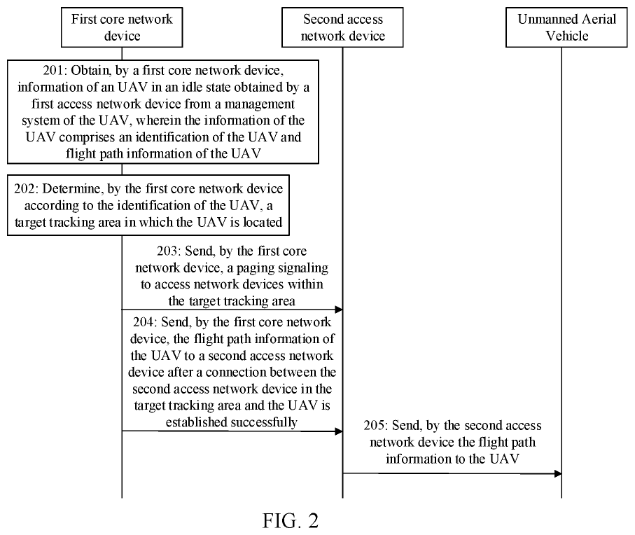

FIG. 2 is a flowchart showing a method for providing a flight path of an Unmanned Aerial Vehicle (UAV) according to an exemplary embodiment. The method may be applied to the network architecture shown in FIG. 1. The method may include the following steps.

In step 201, the first core network device obtains information of an UAV in an idle state obtained by a first access network device from the management system of the UAC. The information of the UAV includes an identification of the UAV and flight path information of the UAV.

In the embodiments of the present disclosure, a technical solution for providing flight path information to the UAV in the idle state by an access network device is provided. The first access network device may be any one of the access network devices in the access network, and it may obtain information of the UAV from the management system of the UAV. The information of the UAV includes the identification of the UAV and the flight path information of the UAV. The identification of the UAV is used to uniquely identify the UAV, and different UAVs have different identifications. The flight path information of the UAV may include the flight path of the UAV. For example, the flight path of the UAV may be a flight path planned for the UAV by the management system of the UAV.

The core network devices involved in the embodiments of the present disclosure are mobility management network elements in the core network. The mobility management network elements are functional network elements responsible for access authentication and mobility management. For example, in an LTE system, a mobility management network element may be MME. In the 5G NR system, a mobility management network element may be AMF entity.

An RRC connection between the access network devices and the UAV may be established, through which signaling and/or data are transmitted. Optionally, based on the state of the RRC connection, the state of the UAV may be divided to include an idle state, a connected state, and an inactive state. The idle state means that RRC connection between the UAV and the access network device has not been established. The connection state means that an RRC connection between the UAV and the access network devices has been established, and the RRC connection is in an active state. An inactive state means that an RRC connection between the UAV and the access network device has been established, but the RRC connection is in an inactive state.

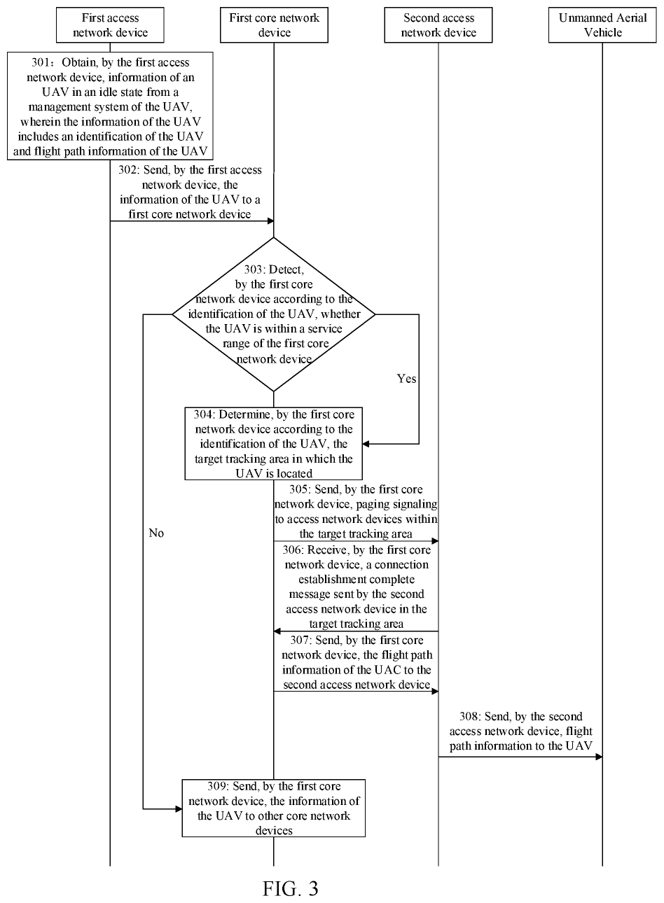

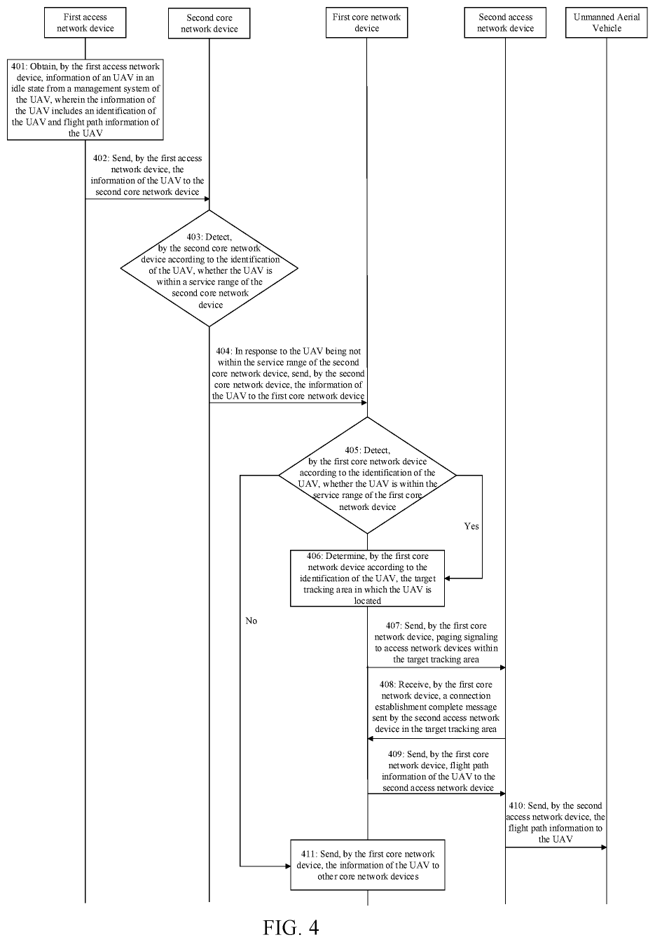

The first core network device may receive the information of the UAV directly from the first access network device or may receive the information of the UAV from a second core network device, and the information of the UAV is received by the second core network device from the first access network device or other core network devices. The first core network device, the second core network device, and other core network devices herein are all core network devices deployed in the core network, such as an MME or an AMF entity. The detailed flow of receiving the information of the UAV by the first core network device may be explained with reference to the description in the following embodiments of FIG. 3 and FIG. 4.

In addition, the core network devices may interact with the access network devices through a communication interface. For example, in an LTE system, the above communication interface is an S1 interface. In the 5G NR system, the above communication interface is a NG interface.

In step 202, the first core network device determines a target tracking area in which the UAV is located according to the identification of the UAV.

In response to the UAV being within a service range of the first core network device, the first core network device determines the target tracking area in which the UAV is located according to the identification of the UAV.

The tracking area is a concept proposed by a communication system for location management of terminals (including a handset, a UAV, and the like), and is defined as a free moving area in which the terminal does not need to update a service. The core network device divides its service range into a plurality of tracking areas, each tracking area may include coverage ranges of one or more access network devices, i.e., each tracking area may include one or more cells. The function of the tracking area is to manage the terminal position. Each tracking area is configured with its own unique tracking area identification, and the tracking areas cannot overlap with each other. In addition, when a terminal moves from one tracking area to another, the location registration is re-performed on the new tracking area to notify the core network device to change the location information of the terminal stored by the core network device, that is, the tracking area is updated, so that the core network device may know which tracking area the terminal in the idle state is in.

Therefore, the first core network device may store the identification of the UAV in each tracking area within the service range of the first core network device. When the UAV is within the service range of the first core network device, the first core network device may find the target tracking area in which the UAV is located from the stored information according to the identification of the UAV.

In addition, when the UAV is not within the service range of the first core network device, the first core network device sends information of the UAV to other core network devices. For example, the first core network device sends the information of the UAV to one or more other core network devices adjacent to or connected to the first core network device. After receiving the information of the UAV, the other core network device may also detect whether the UAV is within its own service range. When the UAV is within service range of the other core network device, the other core network device determines the target tracking area in which the UAV is located according to the identification of the UAV. When the UAV is not within service range of the other core network device, the other core network device may further send the information of the UAV to one or more other core network devices adjacent to or connected to it.

A core network device (such as the first core network device described above or other core network devices that have received information of the UAV) may detect whether the UAV is within the service range of the core network device according to the identification of the UAV. For example, the core network device may store the identification of the UAV included in each tracking area within its service range. When the identification of the UAV recorded in a certain tracking area includes the identification of the to-be-detected UAV, the core network device determines that the to-be-detected UAV is within its service range, and determines the above tracking area to be the target tracking area in which the to-be-detected UAV is located. When the identifications of the UAV recorded in all the tracking areas within the service range do not include the identification of the to-be-detected UAV, the core network device determines that the to-be-detected UAV is not within its service range.

In step 203, the first core network device sends paging signaling to the access network devices in the target tracking area.

After determining the target tracking area in which the UAV is located, the first core network device may perform paging in all cells within the target tracking area to know the cell in which the UAV is located. Optionally, the first core network device sends the paging signaling to all access network devices within the target tracking area. The paging signaling is used to instruct the access network devices to page the UAV. Optionally, the identification of the UAV is included in the above paging signaling.

After the access network device receives the paging signaling, the UAV is paged by a RAN-initiated paging. For example, the access network device sends a paging message for paging the UAV. Optionally, the identification of the UAV is included in the paging message. The UAV may receive paging messages sent by an access network device in a cell in which the UAV is located, for example, the UAV receives the paging message sent by a second access network device.

In step 204, after the connection between the second access network device and the UAV in the target tracking area is established successfully, the first core network device sends the flight path information of the UAV to the second access network device.

After receiving the paging message sent by the second access network device, the UAV may determine whether the received paging message is used for paging the UAV itself according to the identification of the UAV carried in the paging message. If the UAV determines that the paging message is used for paging the UAV itself, the UAV may initiate a random access to the second access network device to request establishing a connection with the second access network device. For example, the UAV sends an RRC Connection Request to the second access network device. The RRC Connection Request is used to request establishing a connection with the second access network device. After receiving the RRC Connection Request sent by the UAV, the second access network device establishes an RRC connection with the UAV according to the RRC Connection Request. In addition, if the UAV determines that the paging message received by it is not used for paging the UAV itself, it is not needed to perform the step of sending an RRC Connection request to the second access network device, and the UAV may remain in the idle state.

After the above connection between the second access network device and the UAV is established successfully, a connection establishment complete message may be sent to the first core network device. The connection establishment complete message is used to indicate that the connection between the second access network device and the UAV has been established successfully. The first core network device sends the flight path information of the UAV to the second access network device after receiving the connection establishment complete message.

In step 205, the second access network device sends the flight path information to the UAV.

After receiving the flight path information of the UAV, the second access network device sends the flight path information of the UAV to the UAV through the above connection established with the UAV. For example, when there is an RRC connection between the second access network device and the UAV, the second access network device may send an RRC message to the UAV through the RRC connection. The the flight path information of the UAV is carried in the RRC message.

In view of above, in the technical solution provided in the embodiments of the present disclosure, for the UAV in the idle state, after obtaining the flight path information of the UAV from the access network device, the core network device searches for the target tracking area in which the UAV is located, then instructs the access network devices in the target tracking area to page the UAV. And after any one of access network devices finds the UAV and successfully establishes the connection with the UAV, the core network device sends the flight path information to the UAV through the access network device. Therefore, the transmission of the flight path information of UAV is implemented, thereby enabling the UAV to obtain the flight path information.

FIG. 3 is a flowchart showing a method for providing a flight path of an Unmanned Aerial Vehicle (UAV) according to another exemplary embodiment. The method may be applicable to the network architecture shown in FIG. 1. In the present embodiment, it is assumed that the core network device accessed by the first access network device is the first core network device, and the method may include the following steps.

In step 301, the first access network device obtains information of an UAV in an idle state from a management system of the UAV. The information of the UAV includes an identification of the UAV and flight path information of the UAV.

In step 302, the first access network device sends the information of the UAV to the first core network device.

In the embodiment, since the core network device accessed by the first access network device is the first core network device, the first access network device may directly send the information of the UAV to the first core network device.

In step 303, the first core network device detects whether the UAV is within a service range of the first core network device according to the identification of the UAV. If yes, the following steps 304-308 are performed. If not, the following step 309 is performed.

In step 304, the first core network device determines the target tracking area in which the UAV is located according to the identification of the UAV.

In step 305, the first core network device sends paging signaling to access network devices within the target tracking area.

In step 306, the first core network device receives a connection establishment complete message sent by a second access network device in the target tracking area.

In step 307, the first core network device sends the flight path information of the UAC to the second access network device.

In step 308, the second access network device sends flight path information to the UAV.

In step 309, the first core network device sends the information of the

UAV to other core network devices.

After receiving the information of the UAV, the other core network device may perform the same or similar steps as the above steps 303-309, finally find the UAV in the idle state, and send the flight path information of the UAV to the UAV.

FIG. 4 is a flowchart showing a method for providing a flight path of an Unmanned Aerial Vehicle (UAV) according to another exemplary embodiment. The method may be applicable to the network architecture shown in FIG. 1. In the present embodiment, it is assumed that the core network device accessed by the first access network device is the second core network device, and the method may include the following steps.

In step 401, the first access network device obtains information of an UAV in an idle state from a management system of the UAV. The information of the UAV includes an identification of the UAV and flight path information of the UAV.

In step 402, the first access network device sends the information of the UAV to the second core network device.

In the embodiment, since the core network device accessed by the first access network device is the second core network device, the first access network device sends the information of the UAV to the second core network device.

In step 403, the second core network device detects whether the UAV is in a service range of the second core network device according to the identification of the UAV.

In step 404, in response to the UAV being not within the service range of the second core network device, the second core network device sends the information of the UAV to the first core network device.

In response to the UAV being not within the service range of the second core network device, the second core network device may send the information of the UAV to other core network devices. For example, the second core network device sends the information of the UAV to one or more other core network devices (for example, including the first core network device) adjacent to or connected to the second core network device.

In addition, in response to the UAV being within the service range of the second core network device, the second core network device may determine the target tracking area in which the UAV is located according to the identification of the UAV, and then perform a process of paging the UAV. The process of paging the UAV by the second core network device is the same as or similar to the process of paging the UAV by the first core network device, and and details are not described herein.

In step 405, the first core network device detects whether the UAV is within the service range of the first core network device according to the identification of the UAV. If yes, the following steps 406-410 are performed. If not, the following step 411 is performed.

In step 406, the first core network device determines the target tracking area in which the UAV is located according to the identification of the UAV.

In step 407, the first core network device sends paging signaling to access network devices within the target tracking area.

In step 408, the first core network device receives a connection establishment complete message sent by the second access network device in the target tracking area.

In step 409, the first core network device sends flight path information of the UAV to the second access network device.

In step 410, the second access network device sends the flight path information to the UAV.

In step 411, the first core network device sends the information of the UAV to other core network devices.

After receiving the information of the UAV, the other core network devices may perform the same or similar steps as the above steps 303-309, finally find the UAV in the idle state, and send the flight path information of the UAV to the UAV.

For details not described in detail in the above embodiments of FIG. 3 and FIG. 4, reference may be made to the embodiment of FIG. 2.

It should be noted that it is assumed that the first access network device obtains the information of the UAV in the idle state from the management system of the UAV. If the access network device that finally finds the UAV by paging is also the first access network device, the first access network device may send a connection establishment complete message to the core network device to which the first access network device is connected according to the procedure described above, and then sends the flight path information to the UAV after receiving the flight path information of the UAV sent by the core network device. Alternatively, the first access network device may directly send the flight path information included in the information obtained from the management system of the UAV to the UAV.

It should also be noted that in the above method embodiments, the technical solution of the present disclosure is described only in terms of interaction among the core network device, the access network device and the UAV. The steps described above with respect to the first core network device may be individually implemented as a method for providing the flight path of UAV on the first core network device side. The steps described above with respect to the second access network device may be individually implemented as a method for providing the flight path of UAV on the second access network device side.

The following is an apparatus embodiment of the present disclosure, which may be used to perform the method embodiments of the present disclosure. For details not described in the apparatus embodiments of the present disclosure, reference is made to the method embodiments of the present disclosure.

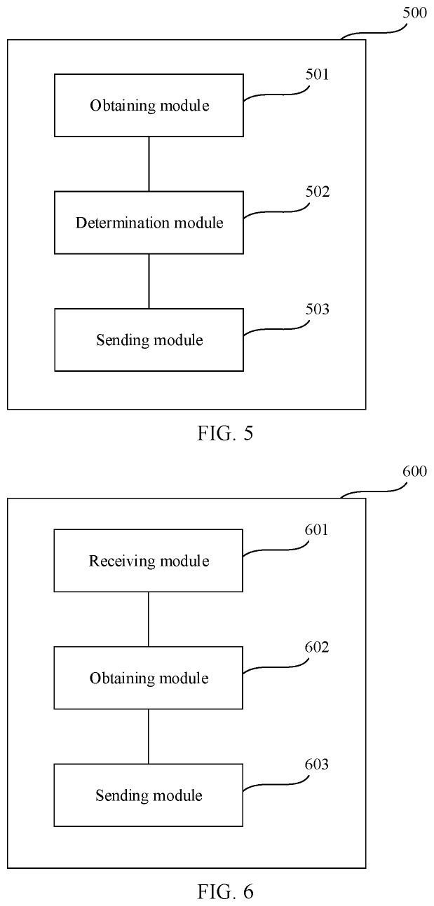

FIG. 5 is a block diagram showing an apparatus for providing a flight path of an Unmanned Aerial Vehicle (UAV) according to an exemplary embodiment. The apparatus has a function of implementing the above method examples of core network device side. The function may be implemented by hardware, or may be implemented by executing corresponding software through hardware. The apparatus 500 may be the first core network device described above, or may be configured in the first core network device. The apparatus 500 may include an obtaining module 501, a determination module 502, and a sending module 503.

The obtaining module 501 is configured to obtain information of an UAC in an idle state obtained by a first access network device from a management system of the UAV. The information of the UAV includes an identification of the UAV and flight path information of the UAV.

The determination module 502 is configured to determine a target tracking area in which the UAV is located according to the identification of the UAV.

The sending module 503 is configured to send paging signaling to access network devices within the target tracking area. The paging signaling is used to instruct paging the UAV.

The sending module 503 is further configured to send the flight path information of the UAV to the second access network device after a connection between the second access network device in the target tracking area and the UAV is established successfully.

In view of above, in the technical solution provided in the embodiments of the present disclosure, for the UAV in the idle state, after obtaining the flight path information of the UAV from the access network device, the core network device searches for the target tracking area in which the UAV is located, then instructs the access network devices in the target tracking area to page the UAV. And after any one of the access network devices finds the UAV and successfully establishes a connection with the UAV, the core network device sends the flight path information to the UAV through the access network device. Therefore, the transmission of the flight path information of UAV is implemented, thereby enabling the UAV to obtain the flight path information.

In an alternative embodiment provided based on the embodiment of FIG. 5, the obtaining module 501 is configured to receive information of the UAV from the first access network device.

In another optional embodiment provided based on the embodiment of FIG. 5, the obtaining module 501 is configured to receive information of the UAV from a second core network device. The information of the UAV is received by the second core network device from the first access network device or other core network devices.

In another optional embodiment provided based on the embodiment of FIG. 5 or any one of the above optional embodiments, the apparatus 500 further includes a detection module (not shown in FIG. 5).

The detection module is configured to detect whether the UAV is within a service range of the first core network device according to the identification of the UAV.

The determination module 502 is further configured to: in response to the UAV being within the service range of the first core network device, determine a target tracking area in which the UAV is located according to the identification of the UAV.

Optionally, the sending module 503 is further configured to: in response to the UAV being not within the service range of the first core network device, send the information of the UAV to other core network devices.

In another optional embodiment provided based on the embodiment of FIG. 5 or any one of the above optional embodiments, the apparatus 500 further includes a receiving module (not shown in FIG. 5).

The receiving module is configured to receive a connection establishment complete message sent by the second access network device. The connection establishment complete message is used to indicate that the connection between the second access network device and the UAV is established successfully.

The sending module 503 is further configured to send the flight path information of the UAV to the second access network device after the connection establishment complete message is received.

FIG. 6 is a block diagram showing an apparatus for providing a flight path of an Unmanned Aerial Vehicle (UAV) according to another exemplary embodiment. The apparatus has a function of implementing the above method examples of second access network device side. The function may be implemented by hardware, or may be implemented by executing corresponding software through hardware. The apparatus may be the second access network device described above, or may be configured in the second access network device. The apparatus 600 may include a receiving module 601, an obtaining module 602, and a sending module 603.

The receiving module 601 is configured to receive paging signaling sent by a first core network device. The paging signaling is used to instruct paging an UAV in an idle state, and the second access network device is located in a target tracking area in which the UAV is located.

The obtaining module 602 is configured to obtain flight path information of the UAV from the first core network device in response to the connection with the UAV being established successfully.

The sending module 603 is configured to send the flight path information to the UAV.

In view of above, in the technical solution provided in the embodiments of the present disclosure, for the UAV in the idle state, after obtaining the flight path information of the UAV from the access network device, the core network device searches for the target tracking area in which the UAV is located, then instructs the access network devices in the target tracking area to page the UAV. And after any one of access network devices finds the UAV and successfully establishes a connection with the UAV, the core network device sends the flight path information to the UAV through the access network device. Therefore, the transmission of the flight path information of UAV is implemented, thereby enabling the UAV to obtain the flight path information.

In an optional embodiment provided based on the embodiment of FIG. 6, the obtaining module 602 is configured to: send a connection establishment complete message to the first core network device, and receive flight path information of the UAV sent by the first core network device. The connection establishment complete message is used to indicate that the connection between the second access network device and the UAV is established successfully.

In another optional embodiment provided based on the FIG. 6 embodiment, the apparatus 600 further includes a connection establishment module (not shown in FIG. 6).

The sending module 603 is further configured to send a paging message for paging the UAV according to the paging signaling.

The receiving module 601 is further configured to receive a connection establishment request sent by the UAV after receiving the paging message.

The connection establishment module is configured to establish the connection with the UAV according to the connection establishment request.

It should be noted that the apparatuses provided in the above embodiments are described by way of example only in terms of the division of each of the above functional modules when implementing their functions. In practical application, the above function may be allocated to be performed in different functional modules according to practical requirements. That is, the content structure of the apparatus is divided into different functional modules to perform all or part of the functions described above.

With respect to the apparatuses in the above embodiments, the specific manner of performing operations by each module has been described in detail in the embodiments of the the method, and will not be described in detail herein.

An exemplary embodiment of the present disclosure also provides a device for providing flight path of an Unmanned Aerial Vehicle (UAV) capable of implementing the method for providing flight path of an UAV provided by the present disclosure. The device may be applicable to the first core network device described above, or may be configured in the first core network device. The device may include a processor, and memory for storing instructions executable for the processor. The processor is configured to: obtain information of the UAV in an idle state obtained by a first access network device from management system of the UAV, the information of the UAV including an identification of the UAV and flight path information of the UAV, determine a target tracking area in which the UAV is located according to the identification of the UAV, send paging signaling to access network devices within the target tracking area, the paging signaling being used to instruct paging the UAV, and send flight path information of the UAV to the second access network device after a connection between the second access network device in the target tracking area and the UAV is established successfully.

Optionally, the processor is further configured to receive the information of the UAV from the first access network device.

Optionally, the processor is further configured to receive the information of the UAV from a second core network device, the information of the UAV being received by the second core network device from the first access network device or other core network devices.

Optionally, the processor is further configured to detect whether the UAV is within a service range of the first core network device according to the identification of the UAV, and in response to the UAV being within the service range of the first core network device, determine the target tracking area in which the UAV is located according to the identification of the UAV.

Optionally, the processor is further configured to: in response to the UAV being not within the service range of the first core network device, send the information of the UAV to other core network devices.

Optionally, the processor is further configured to receive a connection establishment complete message sent by the second access network device, the connection establishment complete message being used to indicate that the connection between the second access network device and the UAV is established successfully, and send the flight path information of the UAV to the second access network device after the connection establishment complete message is received.

An exemplary embodiment of the present disclosure also provides a device for providing a flight path of an Unmanned Aerial Vehicle (UAV) capable of implementing the method for providing a flight path of an UAV provided by the present disclosure. The device may be applicable to the second access network device described above, or may be configured in the second access network device. The device may include a processor, and memory for storing instructions executable for the processor.

The processor is configured to: receive paging signaling sent by a first core network device, the paging signaling being used to instruct that paging an UAV in an idle state, the second access network device being located in a target tracking area in which the UAV is located, in response to a connection between the second access network device and the UAV being established successfully, obtain flight path information of the UAV from the first core network device, and send the flight path information to the UAV.

Optionally, the processor is further configured to send a connection complete message to the first core network device, the connection establishment complete message being used to indicate that the connection between the second access network device and the UAV is established successfully, and receive the flight path information of the UAV sent by the first core network device.

Optionally, the processor is further configured to send a paging message for paging the UAV according to the paging signaling, receive a connection establishment request which is sent by the UAV after receiving the paging message, and establish the connection with the UAV according to the connection establishment request.

An exemplary embodiment of the present disclosure also provides a system for providing a flight path of an Unmanned Aerial Vehicle (UAV) including a first core network device and a second access network device as described above.

The above describes the technical solutions provided in the embodiments of the present disclosure mainly from the perspectives of the first core network device and the second access network device. It should be understood that the first core network device and the second access network device include corresponding hardware structures and/or software modules for performing the respective functions in order to implement the above functions. In combination with the units and algorithm steps of the each of examples described in the embodiments in the present disclosure, the embodiments of the present disclosure may be implemented in hardware or a combination of hardware and computer software. Whether a function is performed in hardware or computer software-driven hardware is depend on the particular application and design constraints of the technical solutions. Those skilled in the art may use different methods to implement the described functions for each particular application, but such implementation should not be considered to be beyond the scope of the technical solutions of the embodiments of the present disclosure.

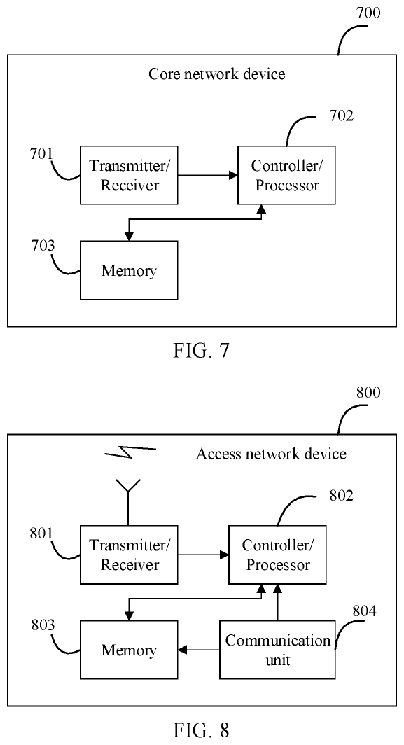

FIG. 7 is a schematic structural diagram showing a core network device according to an exemplary embodiment.

The core network device 700 includes a transmitter/receiver 701 and a processor 702.

The functions of the core network device 700 are mainly providing a user connection, managing users, and performing bearers for services, and providing an interface to an external network as a bearer network. Optionally, the core network device 700 is a mobility management network element in the core network. A mobility management network element is a functional network element responsible for access authentication and mobility management. For example, in an LTE system, the mobility management network element may be an MME. In the 5G NR system, the mobility management network element may be an AMF entity. The processor 702 is configured to implement the above functions of the core network device 700 and to perform the processes performed by the core network device 700 in the above embodiments of the present disclosure. For example, the processor 702 is configured to perform various steps on the first core network device side in the above method embodiments, and/or other steps of the technical solutions described in the embodiments of the present disclosure.

Further, the core network device 700 may further include memory 703 for storing program codes and data used for the core network device 700.

It should be understood that FIG. 7 shows only a simplified design of the core network device 700. In practical applications, the core network device 700 may include any number of transmitters, receivers, processors, memories, and the like, while all core network devices that may implement embodiments of the present disclosure are within the scope of the embodiments of the present disclosure.

FIG. 8 is a schematic structural diagram showing an access network device according to an exemplary embodiment.

The access network device 800 includes a transmitter/receiver 801 and a processor 802. Here, the processor 802 may also be a controller. It is shown in FIG. 8 as “controller/processor 802”. The transmitter/receiver 801 is configured to support transceiving information between the access network device 800 and the terminal, and support communication between the access network device 800 and other network entities. The processor 802 performs various functions for communicating with terminals. In the uplink, an uplink signal from the terminal is received via an antenna, demodulated by a receiver 801 (e.g., a high frequency signal is demodulated into a baseband signal), and further processed by a processor 802 to recover service data and signaling information transmitted by the terminal. In the downlink, service data and signaling messages are processed by the processor 802 and modulated (e.g., the baseband signal is modulated into a high frequency signal) by the transmitter 801 to generate a downlink signal and sent to the terminal via an antenna. It should be noted that the above demodulation or modulation functions may also be performed by the processor 802. For example, the processor 802 is further configured to perform various steps of above method embodiments for the access network device side (such as the first access network device or the second access network device), and/or other steps of the technical solutions described in the embodiments of the present disclosure.

Further, the access network device 800 may further include memory 803 for storing program codes and data of the access network device 800. In addition, the access network device may further include a communication unit 804. The communication unit 804 is configured to support communication between the access network device and other network entities (such as network devices in a core network). For example, in an LTE system, the communication unit 804 may be a S1-U interface for supporting communication between the access network device and the S-GW. Alternatively, the communication unit 804 may be an S1-MME interface for supporting communication between the access network device and the MME. In the 5G NR system, the communication unit 804 may be a NG-U interface for supporting communicate between the access network device and the UPF entity. Alternatively, the communication unit 804 may be an NG-C interface for supporting access AMF entity to communication.

It should be understood that FIG. 8 shows only a simplified design of the access network device 800. In practical applications, access network device 800 may include any number of transmitters, receivers, processors, controllers, memories, communication units, and the like, while all access network devices that may implement embodiments of the present disclosure are within the scope of the embodiments of the present disclosure.

An exemplary embodiment of the present disclosure also provides a non-transitory computer-readable storage medium in which computer programs are stored. When the computer programs are executed by a processor of the first core network device, the steps described above with respect to a method for providing a flight path of an Unmanned Aerial Vehicle (UAV) on the first core network device side are implemented.

Another exemplary embodiment of the present disclosure also provides a non-transitory computer-readable storage medium in which computer programs are stored. When the computer programs are executed by a processor of a second access network device, the steps described above with respect to a method for providing a flight path of an Unmanned Aerial Vehicle (UAV) on the second access network device side are implemented.

It should be understood that the “plurality” mentioned herein refers to two or more. “And/or”describes the association relationship of the associated object, indicating that there may be three relationships, for example, A and/or B, which may mean the following three cases: A exists alone, A and B exist at the same time, and B exists alone. The character “/” generally indicates that the associated objects are in an “or” relationship.

Other embodiments of the present disclosure will readily occur to those skilled in the art upon consideration of the specification and practice of the disclosure disclosed herein. The disclosure is intended to cover any variations, uses, or adaptive of the present disclosure. These variations, uses, or adaptive changes follow the general principles of the present disclosure and include common general knowledge or conventional technical means in the technical field, which are not disclosed in the present disclosure. The specification and the embodiments are considered as being exemplary only. The true scope and spirit of the present disclosure are indicated by the following claims.

It should be understood that the present disclosure is not limited to the exact construction that has been described above and illustrated in the accompanying drawings, and that various modifications and changes may be made without departing from the scope thereof. The scope of the present disclosure is limited only by the appended claims.

1. A method for providing a flight path of an Unmanned Aerial Vehicle (UAV), comprising:
obtaining, by a first core network device, information of an UAV in an idle state obtained by a first access network device from a management system of the UAV, wherein the information of the UAV comprises an identification of the UAV and flight path information of the UAV;
determining, by the first core network device according to the identification of the UAV, a target tracking area in which the UAV is located;
sending, by the first core network device, a paging signaling to access network devices within the target tracking area, wherein the paging signaling is configured to instruct paging the UAV; and
sending, by the first core network device, the flight path information of the UAV to a second access network device after a connection between the second access network device in the target tracking area and the UAV is established successfully.

2. The method of claim 1, wherein obtaining, by the first core network device, the information of the UAV in the idle state obtained by the first access network device from the management system of the UAV comprises:
receiving, by the first core network device, the information of the UAV from the first access network device.

3. The method of claim 1, wherein obtaining, by the first core network device, the information of the UAV in the idle state obtained by the first access network device from the management system of the UAV comprises:
receiving, by the first core network device, the information of the UAV from a second core network device, wherein the information of the UAV is received by the second core network device from the first access network device or other core network devices.

4. The method of claim 1, further comprising:
detecting, by the first core network device according to the identification of the UAV, whether the UAV is within a service range of the first core network device; and
in response to the UAV being within the service range of the first core network device, performing, by the first core network device according to the identification of the UAV, the step of determining the target tracking area in which the UAV is located.

5. The method of claim 4, further comprising:
in response to the UAV being not within the service range of the first core network device, sending, by the first core network device, the information of the UAV to other core network devices.

6. The method of claim 1, further comprising:
receiving, by the first core network device, a connection establishment complete message sent by the second access network device, wherein the connection establishment complete message is configured to indicate that the connection between the second access network device and the UAV is established successfully; and
performing, by the first core network device, the step of sending the flight path information of the UAV to the second access network device after the connection establishment complete message is received.

7. A method for providing a flight path of an Unmanned Aerial Vehicle (UAV), comprising:
receiving, by a second access network device, paging signaling sent by a first core network device, wherein the paging signaling is configured to instruct paging an UAV in an idle state, and the second access network device is located within a target tracking area in which the UAV is located;
in response to a connection between the second access network device and the UAV being established successfully, obtaining, by the second access network device, flight path information of the UAV from the first core network device; and
sending, by the second access network device, the flight path information to the UAV.

8. The method of claim 7, wherein obtaining, by the second access network device, the flight path information of the UAV from the first core network device comprises:
sending, by the second access network device, a connection establishment complete message to the first core network device, wherein the connection establishment complete message is configured to indicate that the connection between the second access network device and the UAV is established successfully; and
receiving, by the second access network device, the flight path information of the UAV sent by the first core network device.

9. The method of claim 7, further comprising:
sending, by the second access network device according to the paging signaling, a paging message for paging the UAV;
receiving, by the second access network device, a connection establishment request, which is sent by the UAV after receiving the paging message; and
establishing, by the second access network device, the connection with the UAV according to the connection establishment request.

10. A device for providing a flight path of an Unmanned Aerial Vehicle (UAV), applicable to a first core network device, comprising:
a processor;
memory for storing instructions executable for the processor;
wherein the processor is configured to:
obtain information of an UAV in an idle state obtained by a first access network device from a management system of the UAV, wherein the information of the UAV comprises an identification of the UAV and flight path information of the UAV;
determine, according to the identification of the UAV, a target tracking area in which the UAV is located;
send a paging signaling to access network devices within the target tracking area, wherein the paging signaling is configured to instruct paging the UAV; and
send the flight path information of the UAV to a second access network device after a connection between the second access network device in the target tracking area and the UAV is established successfully.

11. The device of claim 10, wherein the processor is further configured to receive the information of the UAV from the first access network device.

12. The device of claim 10, wherein the processor is configured to receive the information of the UAV from a second core network device, wherein the information of the UAV is received by the second core network device from the first access network device or other core network devices.

13. The device of claim 10, wherein the processor is further configured to:
detect, according to the identification of the UAV, whether the UAV is within a service range of the first core network device; and
in response to the UAV being within the service range of the first core network device, determine, according to the identification of the UAV, the target tracking area in which the UAV is located.

14. The device of claim 12, wherein the processor is further configured to: in response to the UAV being not within the service range of the first core network device, send the information of the UAV to other core network devices.

15. The device of claim 10, wherein the processor is further configured to:
receive a connection establishment complete message sent by the second access network device, wherein the connection establishment complete message is configured to indicate that the connection between the second access network device and the UAV is established successfully; and
send the flight path information of the UAV to the second access network device after the connection establishment complete message is received.

16. A device implementing the method of claim 7, comprising:
a processor;
memory for storing instructions executable for the processor;
wherein the processor is configured to implement steps of the method.

17. The device of claim 16, wherein the processor is further configured to:
send a connection establishment complete message to the first core network device, wherein the connection establishment complete message is configured to indicate that the connection between the second access network device and the UAV is established successfully; and
receive the flight path information of the UAV sent by the first core network device.

18. The device of claim 16, wherein the processor is further configured to:
send, according to the paging signaling, a paging message for paging the UAV;
receive a connection establishment request, which is sent by the UAV after receiving the paging message; and
establish the connection with the UAV according to the connection establishment request.

19. (canceled)

20. (canceled)

21. (canceled)

22. A non-transitory computer readable storage medium in which computer programs are stored, and when the computer programs are executed by a processor, the processor is configured to perform steps of the method of claim 1.

23. The non-transitory computer readable storage medium of claim 22, wherein said obtaining, by the first core network device, the information of the UAV in the idle state obtained by the first access network device from the management system of the UAV comprises:
receiving, by the first core network device, the information of the UAV from the first access network device;
the method further comprising:
after any one of the access networks devices finds the UAV and successfully establishes a connection with the UAV, the core network device sending the flight path information to the UAV through the one of the access network devices, thereby enabling the UAV to obtain the flight path information.
